(19) United States
(12) Patent Application Publication
(10) Pub. No.: US 2008/0093486 A1
(43) Pub. Date: Apr. 24, 2008

(54) WASTE DISINTEGRATOR

(75) Inventor: Lawrence ORUBOR, Calgary (CA)

Correspondence Address: BLAKELY SOKOLOFF TAYLOR & ZAFMAN, 1279 OAKMEAD PARKWAY, SUNNYVALE, CA, 94085-4040, US

(73) Assignee: Orubor Integrated Technology Inc., Calgary (CA)

(21) Appl. No.: 11/757,211

(22) Filed: Jun. 1, 2007

Related U.S. Application Data
(60) Provisional application No. 60/810,764, filed on Jun. 2, 2006.

(51) Int. Cl. B02C 19/00; B02C 23/18

(52) U.S. Cl. 241/15; 241/39

(57) ABSTRACT

A waste disintegrator device of the present invention is designed to clean waste in a confined area, the device including a fluid supply for receiving fluid, a housing for surrounding a waste, a passageway connecting the fluid supply to the housing, and at least one spray jet for dispensing the fluid at the waste.

### CROSS REFERENCE TO RELATED APPLICATIONS

This application claims the benefit of priority of U.S. Provisional Patent Application No. 60/810,764 fled Jun. 2, 2006, which is incorporated herein by reference in its entirety.

### FIELD OF THE INVENTION

The present invention relates generally to a waste disintegrator. More particularly, the present invention relates to a method and device for disintegrating waste in a confined area and for applying a fluid in a confined area.

### BACKGROUND OF THE INVENTION

In known methods of cleaning waste, particularly animal waste, operators have attempted to pick up or remove waste using devices such as p astic bags or pooper scoopers. However, these methods still expose operators to the waste and associated noxious fumes and require some handling of the waste by the operators. Further, such known methods do not completely clean up or remove the waste and in some cases the waste remnants left can be harmful to the environment (such as by contaminating the water table and groundwater).

Few such methods or devices have been made readily available to pet owners who wish to clean up after their pets despite the increase in municipal by-laws requiring such clean up. Since few such methods or devices have been made available, little development has been made in the area of cleaning devices which ensure that a pet owner is not exposed to and does not have to handle any waste.

Other than natural decomposition, the prior art does not teach any devices or methods which eliminate the waste thereby allowing an operator to avoid any handling of the waste.

### SUMMARY OF THE INVENTION

It is an object of the present invention to teach a waste disintegrator which is designed to clean waste in a confined area.

It is an object of the present invention to teach a self-cleaning waste disintegrator which is designed for pet owners to clean their pet's waste.

It is another object of the present invention to provide a natural manure to fertilize grass when operators clean up animal waste without environmental contamination.

In a first aspect, the present invention provides a waste disintegrating device for disintegrating a target waste located in an affected area having a spraying system for spraying the target waste; a fluid supply system for providing fluid to the spraying system, the fluid supply system in fluid communication with the spraying system; and a housing system enclosing the spraying system for surrounding the target waste for reducing the amount of spray and waste escaping the affected area as the waste is sprayed by the spraying system.

Preferably the fluid is water or a chemical designed specifically for interacting with the particular type of waste. Preferably the fluid supply system is detachable. Preferably the fluid supply system is in fluid communication with the spraying system by a hose. Preferably the hose is detachable. Preferably the housing system is detachable. Preferably the fluid supply system includes a connector for connecting a hose or other fluid supply to the fluid supply system. Preferably the fluid supply system includes a connector for connecting to a power supply. Preferably the power supply is a battery. Preferably the device includes a controller for controlling the fluid pressure provided by the fluid supply system to the spraying system.

Preferably the device includes a controller for adjusting the quantity of fluid being provided to the spraying system by the fluid supply system. Preferably the device includes a controller for controlling the fluid rate provided by the fluid supply system to the spraying system. Preferably the controller is driven by an electric motor. Preferably the electric motor is powered by a source of electricity. Preferably the electric motor is powered by a gasoline engine via an electric generator. Preferably the electric motor is powered by portable power means. Preferably the portable power means is a battery.

Preferably the device includes a wheel for moving the device and for keeping the device upright when not in use. Preferably the device includes a carriage handle.

Preferably the device includes a protective shield adapted to prevent splashing of an operator with fluid or waste which escapes from the housing system.

In a further aspect, the present invention provides a waste disintegrator device having a fluid supply reservoir for receiving a fluid; a chemical fluid reservoir for storing chemical fluid, an inner housing having a spray jet for disintegrating waste and a spray nozzle for decomposing waste; an outer housing for covering the inner housing, the outer housing having a spray jet for cleaning the surface of the inner housing, and a passageway for fluid communication between the fluid supply reservoir and the chemical fluid reservoir and the spray jet and the nozzle of the inner housing and the outer housing.

Preferably, the fluid supply reservoir is filled and then attached to the body of the device. Preferably the fluid is environmentally friendly. Preferably the fluid is one of urine remover fluid, equine solution fluid, odour remover fluid or foaming effect fluid. Preferably the fluid is adapted to at least partially decompose animal waste. Preferably the fluid is adapted to provide a fumigating effect.

Preferably the chemical fluid reservoir includes an indicator for allowing an operator to visually determine the amount of fluid remaining in the chemical fluid reservoir.

Preferably the device includes a rotatable blade in the interior of the inner housing, the rotatable blade adapted to break up the waste. Preferably the device includes a twisted lobe rotatable liner in the interior of inner housing, the twisted lobe rotatable line adapted to break up the waste.

In a further aspect, the present invention provides a waste disintegrator device having a connector for connecting a fluid reservoir; a chemical fluid reservoir for storing a chemical fluid, an inner housing having a spray let for disintegrating waste and a spray nozzle for decomposing waste; an outer housing covering the inner housing, the outer housing having a spray jet for cleaning the surface of the inner housing; a foldable passageway for fluid communication between the fluid reservoir, the chemical fluid reservoir, and the spray jet and nozzle of the inner housing and the outer housing; and a leash system for retaining various types of retractable leash device.

Preferably the leash system includes at least one connector to allow an operator to attach a leash to the device. Preferably the foldable passageway includes a telescoping mechanism.

In a further aspect, the present invention provides a method for disintegrating waste by containing the waste within a confined area; and spraying the waste with a pressurized jet of fluid, wherein the waste is disintegrated by the pressurized fluid jet.

In a further aspect, the present invention provides a method for removing a weed by containing the weed within a confined area; and spraying the weed with a pressurized jet of fluid, wherein the weed is removed by the pressurized fluid jet.

In a further aspect, the present invention provides a method for removing a weed by containing the weed within a confined area; and spraying the weed with a jet of fluid, wherein the fluid is a herbicide.

Other aspects and features of the present invention will become apparent to those ordinarily skilled in the art upon review of the following description of specific embodiments of the present invention.

### BRIEF DESCRIPTION OF THE DRAWINGS

Embodiments of the present invention will be described by way of example only, with references to the attached figures where:

FIG. 1 is a perspective view of a device in accordance with the present invention;

FIG. 2 is a perspective view of a device in accordance with further embodiment of the present invention;

FIG. 3 is a cross sectional view of housing means of FIG. 2 in accordance with a further embodiment of the present invention;

FIG. 4 is a perspective view of a device in accordance with a further embodiment of the present invention; and

FIG. 5 is a perspective view of a device and a cross sectional view of housing means in accordance with the present invention.

### DETAILED DESCRIPTION OF THE INVENTION

The device 100 generally includes a fluid supply system 10, spraying system 20, and a housing system 30 which are all integrated with or removable and engageable to form the device 100.

Fluid Supply System

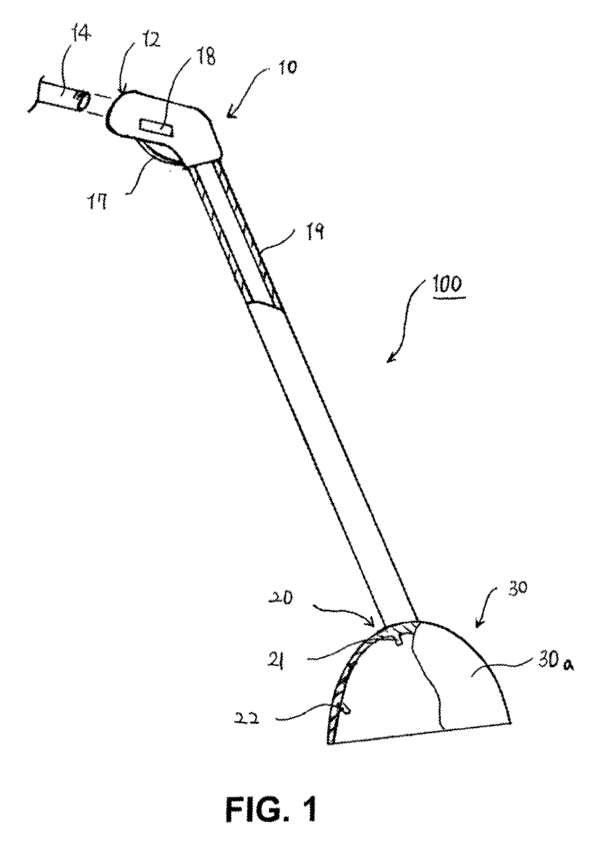

Referring to FIG. 1, the fluid supply system 10 includes a connector 12 which is connectable to a regular fluid supply hose 14 to receive fluid. The fluid supplied to the connecter 12 may be water, a chemical or other fluid known to help disintegrate waste. Those skilled in the art will appreciate that the fluid may have a number of properties well suited to washing, breaking down, disintegrating, deodorizing detoxifying, disinfecting or foaming the waste (or any combination of these) and may even cause the waste to act as a fertilizer once it is broken down.

In one embodiment shown in FIG. 1 the device 100 includes a controller 18 for adjusting fluid pressure or flow rate provided by the fluid supply system 10.

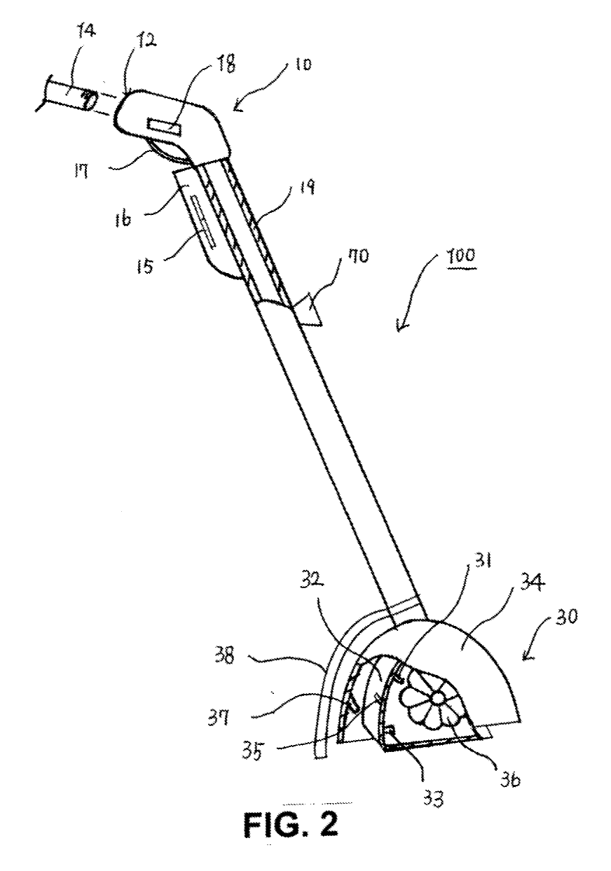

Referring to FIGS. 2, 4 and 5, the fluid supply system 10 may, in addition to (or in lieu of) the connector 12 described in conjunction with FIG. 1, include a fluid reservoir 16 which can be connected to the device 100 to provide fluid to the device 100.

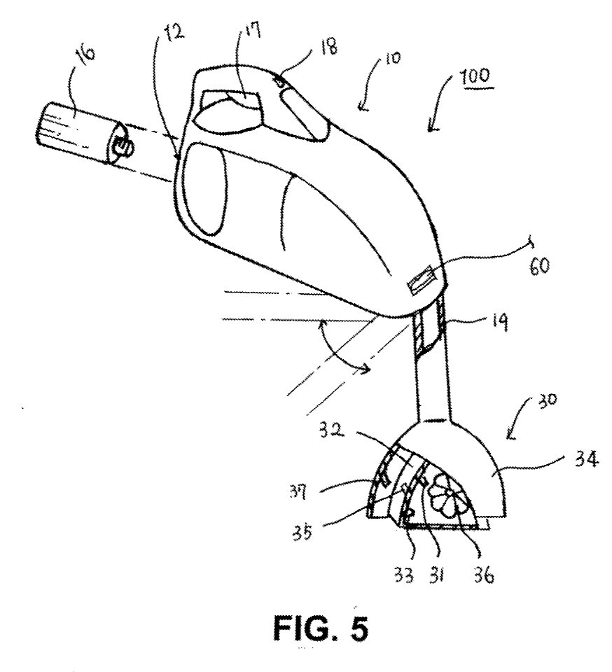

In one embodiment, the controller 18 may allow an operator to switch between using fluid supplied by the connector 12 or by the fluid reservoir 16. In another embodiment, the controller 18 may also allow an operator to select between at least two different chemicals stored in fluid reservoir 16 or set the ratios provided between the connector 12 and fluid reservoir 16 which can provide a chemical 15. The controller 18 may also include a switch 17 to allow an operator to control fluid pressure or to adjust the amount of chemical 15 in the fluid reservoir 16 provided to the device by a pump (not shown). The pump may be driven by an electric motor or any other power source known to those in art including by way of illustration by electric, gasoline or diesel, battery, fuel cell or other power means for providing the necessary power to the pump (and for providing portable power means in the case of the embodiment shown in FIG. 5).

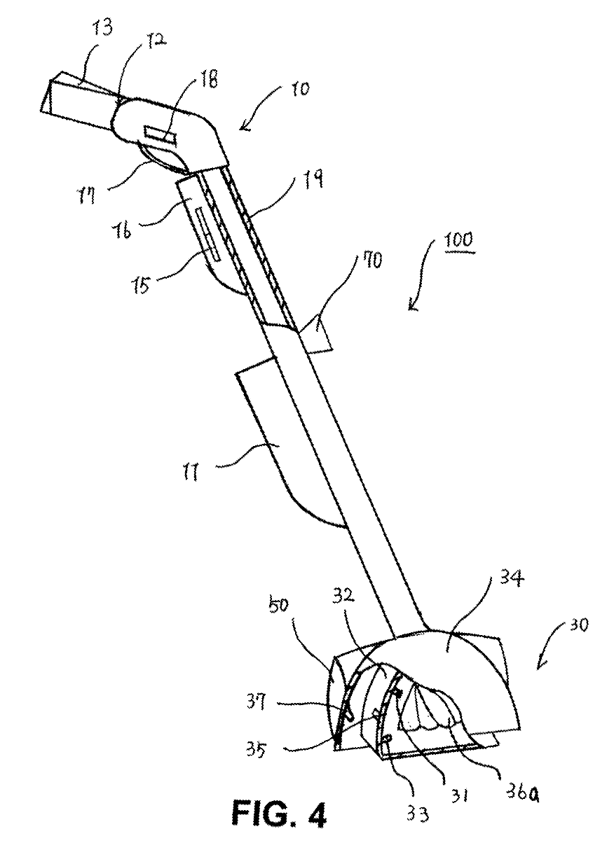

Referring to FIG. 4, the fluid supply system 10 may also include a separate fluid supply reservoir 11 detachable or engageable to the body of device 100.

In one embodiment the connector 12 may be connected to a battery 13 for receiving electric power as shown in FIG. 4. The battery may be of any type known to those skilled in the art, including rechargeable, dry cell batteries. The controller may operate from the power provided by the battery.

In a further embodiment at least a portion of the exterior of the fluid reservoir 16 and fluid supply reservoir 11 may be transparent to allow the operator to visually determine the amount of remaining fluid in the fluid reservoir 16 and the fluid supply reservoir 11 and to determine approximately when the fluid reservoir 16 and the fluid supply reservoir 11 may need refilling.

In a preferred embodiment, the chemical 15 is environmental friendly. The chemical 15 may be concentrated for mixing with fluid provided through connector 12 or for mixing with fluid from one of the reservoirs 11 and 16. One skilled in the art will appreciate that the chemical may be any number of products, some of which are commercially available such as urine remover fluid, equine solution fluid, odour remover fluid, or foaming effect fluid.

In any embodiments of the fluid supply system 10, the fluid supplied to the device 100 and chemical 15 may also convert the waste into a form of fertilizer or fertilizing manure once it is applied to waste, may deodorize or fumigate the waste while the waste is disintegrating in cover 31 or in inner housing 32, may also kill bacteria, may help decompose the waste, may make the waste soluble for groundwater, may make the waste non-toxic for groundwater or have any of the foregoing properties or have any combination of the foregoing effects. In a preferred embodiment a chemical formulation would be used which would accomplish all of the foregoing effects and have all of the foregoing properties.

Spraying System

The fluid supplied through the connector 12 or by the fluid reservoir 16, fluid supply reservoir 11 or some combination of the foregoing travels through a hose 19 to the spraying system 20. The spraying system 20 includes at least one spray jet 21 for dispensing fluid. The spraying system 20 may also include an articulated sprayer or other spraying means for providing a high pressure spray to disintegrate waste. The spraying system 20 may be established in the end of the spray hose 19.

In other embodiments of the various elements of spraying system 20C the hose 19, spray jet 21 or both may be pressurized, the spray jet 21 may be a nozzle or other dispensing means known to those skilled in the art and any number of coordinated spray jets 21, whether moving or stationary, may be provided in addition, one skilled in the art will appreciate that hose 19 is simply a fluid conduit to ensure that the fluid supplied through the connector 12 or by either of the reservoirs 11 or 16 can be provided to spraying system 20.

Housing System

In one embodiment the housing system 30 is a cover 30a similar to a funnel or cap for keeping the waste which is sprayed by spray jet (or jets) 21 to a confined space. The inside of cover 30a may also include a spray jet 22 (as shown in FIG. 1) in fluid communication with the fluid supply system to break down the waste.

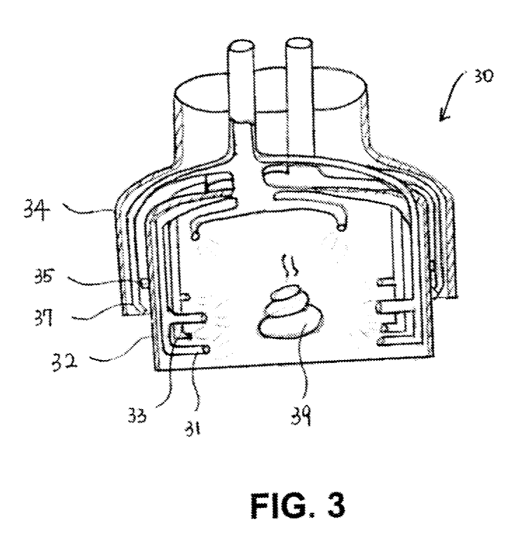

As may be best seen in FIG. 3, the housing system 30 may also include an inner housing 32 for confining the area of the spray from the spray jet 21 and the waste which is splashing as a result of being sprayed and disintegrated to a limited area. Additionally as shown in FIG. 3, housing system 30 may include an outer housing 34. The interior of inner housing 32 may include at least one spray jet 31 for focussing a pressured stream of spray on the waste. Spray jet 31 may also be used to clean the inside of inner housing 32.

FIG. 3 also illustrates a second spray jet 33 for spraying and applying chemicals to the waste for the purposes of deodorizing, disinfecting, foaming, detoxifying or for converting the waste to a useful fertilizer (or some combination of the foregoing) or for simply providing fluid to spray the waste to reduce the amount of time required to disintegrate and break down the waste. Spray jets 31 and 33 may also allow an operator to provide differential supply of fluid from the connector 12 and the reservoirs 11 and 16 to the waste depending on various settings, including those set by controller 18 in some embodiments.

The exterior of inner housing 32 may also include at least one spray nozzle 35 for spraying and applying fluid to clean the interior of outer housing 34.

The outer housing 34 may also include at least one pressurized spray jet 37 for cleaning the surface of the inner housing 32.

Optionally, as shown FIG. 2, the device 100 may include a protective shield 38 for further preventing any fluid or splashing waste to reach the operator.

In a further optional embodiment shown in FIGS. 2 and 5, rotating blades 36 may be located in the interior of the inner housing 32 to break up the waste to reduce the amount of fluid required to disintegrate the waste and for reducing the amount of time required to break apart the waste.

In a further optional embodiment shown in FIG. 4, a rotating liner 36a having twisted lobes on its inner surface may be located in the interior of the inner housing 32 to further break up the waste.

In a still further embodiment, the housing allows an operator to apply fluid or chemical 15 (or both) through the spray jet or jets 21 to a specific area without losing fluid or the chemical 15 to surrounding areas or misapplying the fluid or the chemical 15 to surrounding areas (or both). In an illustrative use for this embodiment, an operator could apply herbicide to a particular weed without affecting the area surrounding the weed or wasting herbicide by applying it to the area surrounding the weed (or both benefits can be achieved). In another illustration of this embodiment, a user could apply a pesticide to a specific area infested by insects without affecting the surrounding areas or wasting pesticide (or achieving both benefits) while containing the insects within the housing while the pesticide is being applied.

Operation

The systems described above work together in a coordinated fashion during operation. More specifically, the operator places cover 30a or inner housing 32 over the target waste 39 or weed or insects (not shown). Cover 33a or inner housing may be placed directly on the ground to increase the efficiency of the device 100, reduce operator fatigue or eliminate splashing of waste outside of the cover 30a or inner housing 32 (or achieve any combination of these benefits).

The operator switches on the controller 18 which controls the fluid pressure or quantity of chemical 15 (or both) used to disintegrate the waste and/or have another desired effect (treatment of insects, weeds). Once the controller 18 is activated, the fluid starts to flow through hose 19 to the spraying system 20. The target waste 39 in the affected area is broken into small particles or disintegrated by high fluid pressure from spray jet or jets 21 or is decomposed through the application of chemical 15.

During the spraying of the waste an object of the device 100 is achieved by reducing or eliminating the amount of waste which, when sprayed, splashes outside of the housing or escapes the affected area in which the waste is located, thereby relieving the operator from being exposed to the waste.

After all of the waste has been broken up (disintegrated), the operator switches off the controller 18 which deactivates the supply of fluid or chemical (or both) to the spray jet or jets 21. At this time the operator can move on to other waste and an object of the device 100 has been achieved by eliminating the need for an operator to handle the waste.

In one embodiment, if the operator wishes to clean the cover 31, inner housing 32 or outer housing 34, the operator places the device 100 on a clean surface where there is not waste. The operator triggers the switch 17 of the controller 18 in accordance with the foregoing description. Once the switch 17 is activated, the fluid starts to discharge through spray jets 31 within interior of either cover 31 or within the inner housing 32 and the outer housing 34. As mentioned above, any of the spray jets may be pressurized to ensure that, in the cleaning mode described here, any caked-on or difficult to disintegrate waste can be cleaned.

### FURTHER EMBODIMENTS

The device 100 is generally portable. While the device 100 may be an upright device as shown in FIGS. 1, 2 and 4, as shown in one embodiment in FIG. 54 the device 100 may even be a handheld device. In the handheld embodiment, elements of the device 100 such as the portion of the body connecting the device 100 to the housing system 30 may be foldable to increase the compactness and portability of the device and such portion may also be telescoping (not shown) to reduce the overall size of the device 100.

In the handheld embodiment shown in FIG. 5, the device 100 may also contain a leash 60 to increase an operator's (in this case pet owner's) convenience as it will allow device 100 to be used as a leash system while allowing an operator to easily dispose of waste. Further in the handheld embodiment, when the operator needs to clean the animal waste, fluid reservoir 16 can be connected to the device 100 to supply fluid or chemical to the spraying system.

The handheld embodiment of device 100 may optionally include a carriage handle 70 to allow the operator to carry the device 100.

The device 100 in any of the upright embodiments may optionally include a wheel system (not shown) for increasing the ease with which the device 100 can be used by increasing its portability and for keeping the device 100 upright when it is not in use. Further, the wheel system (not shown) may reduce operator fatigue while operating the device 100.

One skilled in the art will recognize that as used herein, jet refers to the stream of material/fluid/chemical etc. extending from a nozzle venturi, or other orifice, or refers to the nozzle, venturi, or other orifice forming the jet.

The above-described embodiments of the present invention are intended to be example only. Alterations, modifications and variations may be effected to the particular embodiments by those of skill in the art without departing from the scope of the invention, which is defined solely by the claims appended hereto.

What is claimed is:

1. A waste disintegrating device for disintegrating a target waste located in an affected area comprising.
(a) a spraying system for spraying the target waste;
(b) a fluid supply system for providing fluid to the spraying system, the fluid supply system in fluid communication with the spraying system; and
(c) a housing system enclosing the spraying system for surrounding the target waste for reducing the amount of spray and waste escaping the affected area as the waste is sprayed by the spraying system.

2. A device as in claim 1, wherein the fluid is water.

3. A device as in claim 1, wherein the fluid is a chemical designed specifically for interacting with the particular type of waste.

4. A device as in claim 1, wherein the fluid supply system is detachable.

5. A device as in claim 1, wherein the fluid supply system is in fluid communication with the spraying system by a hose.

6. A device as in claim 5, wherein the hose is detachable.

7. A device as in claim 1, wherein the housing system is detachable.

8. A device as in claim 1, wherein the fluid supply system includes a connector for connecting a hose or other fluid supply to the fluid supply system.

9. A device as in claim 1, wherein the fluid supply system includes a connector for connecting to a power supply.

10. A device as in claim 9, wherein the power supply is a battery.

11. A device as in claim 1, wherein the device includes a controller for controlling the fluid pressure provided by the fluid supply system to the spraying system.

12. A device as in claim 1, wherein the device includes a controller for adjusting the quantity of fluid being provided to the spraying system by the fluid supply system.

13. A device as in claim 1, wherein the device includes a controller for controlling the fluid rate provided by the fluid supply system to the spraying system.

14. A device as in claim 11, wherein the controller is driven by an electric motor.

15. A device as in claim 14, wherein the electric motor is powered by a source of electricity.

16. A device as in claim 14, wherein the electric motor is powered by a gasoline engine via an electric generator.

17. A device as in claim 14, wherein the electric motor is powered by portable power means.

18. A device as in claim 17, wherein the portable power means is a battery.

19. A device as in claim 1, further comprising a wheel for moving the device and for keeping the device upright when not in use.

20. A device as in claim 1, further comprising a carriage handle.

21. A device as in claim 1, further comprising a protective shield adapted to prevent splashing of an operator with fluid or waste which escapes from the housing system.

22. A waste disintegrator device comprising:
(a) a fluid supply reservoir for receiving a fluid;
(b) a chemical fluid reservoir for storing chemical fluid;
(c) an inner housing having a spray jet for disintegrating waste and a spray nozzle for decomposing waste;
(d) an outer housing for covering the inner housing, the outer housing having a spray jet for cleaning the surface of the inner housing; and
(e) a passageway for fluid communication between the fluid supply reservoir and the chemical fluid reservoir and the spray jet and the nozzle of the inner housing and the outer housing.

23. A device as in claim 22, wherein the fluid supply reservoir is filled and then attached to the body of the device.

24. A device as in claim 22, wherein the fluid is environmentally friendly.

25. A device as in claim 22, wherein the fluid is one of urine remover fluid, equine solution fluid, odour remover fluid or foaming effect fluid.

26. A device as in claim 22, wherein the fluid is adapted to at least partially decompose animal waste.

27. A device as in claim 22, wherein the fluid is adapted to provide a fumigating effect.

28. A device as in claim 22, wherein the chemical fluid reservoir includes an indicator for allowing an operator to visually determine the amount of fluid remaining in the chemical fluid reservoir.

29. A device as in claim 22, further comprising a rotatable blade in the interior of the inner housing, the rotatable blade adapted to break up the waste.

30. A device as in claim 22, further comprising a twisted lobe rotatable liner in the interior of inner housing, the twisted lobe rotatable line adapted to break up the waste.

31. A waste disintegrator device comprising:
(a) a connector for connecting a fluid reservoir;
(b) a chemical fluid reservoir for storing a chemical fluid;
(c) an inner housing having a spray jet for disintegrating waste and a spray nozzle for decomposing waste;
(d) an outer housing covering the inner housing, the outer housing having a spray jet for cleaning the surface of the inner housing;
(e) a foldable passageway for fluid communication between the fluid reservoir, the chemical fluid reservoir, and the spray jet and nozzle of the inner housing and the outer housing; and
(f) a leash system for retaining various types of retractable leash device.

32. A device as in claim 31, wherein the leash system includes at least one connector to allow an operator to attach a leash to the device.

33. A device as in claim 31, wherein the foldable passageway includes a telescoping mechanism.

34. A method for disintegrating waste comprising
(a) containing the waste within a confined area, and
(b) spraying the waste with a pressurized jet of fluid,
wherein the waste is disintegrated by the pressurized fluid jet.

35. A method for removing a weed comprising:
(a) containing the weed within a confined area, and
(b) spraying the weed with a pressurized jet of fluid,
wherein the weed is removed by the pressurized fluid jet.

36. A method for removing a weed comprising:
(a) containing the weed within a confined area; and
(b) spraying the weed with a jet of fluid.
wherein the fluid is a herbicide.
